(19) United States
(12) Patent Application Publication
(10) Pub. No.: US 2010/0141146 A1
(43) Pub. Date: Jun. 10, 2010

(54) Turning signal light integrated grip for bikes

(76) Inventor: Yen-Ho Lu, Taichung (TW)

Correspondence Address: Lu, Yen-Ho, 7F-3, No 128, Xiangshang N. Rd, West District, Taichung, 40351, TW

(21) Appl. No.: 12/592,137

(22) Filed: Nov. 20, 2009

(30) Foreign Application Priority Data
Nov. 20, 2008 (TW) 097220768
Mar. 16, 2009 (TW) 098204068

(51) Int. Cl. B60Q 1/14; B62J 6/00

(52) U.S. Cl. 315/77; 362/474

(57) ABSTRACT

This invention proposes a turning-light integrated grip for bikes. Its main features comprises: (1) an invisible wiring is hided inside the grip, and also (2) the turning signal light module is hided and protected inside a corresponding outer ring so that aesthetic merits can be reached. (3) Automatic power-off electrical function makes the product more practical for uses. The whole invention helps enhance the safety of bike riding, and aforementioned features help the product more practical for use and marketing.

### FIELD OF THE INVENTION

The present invention relates to the field of bike safety. The invention integrates turning signal light and grip into one product for bike industry. While reaching expected functions, it also takes care of aesthetic merits, making this invention more practical and appealing to the users.

### BACKGROUND OF THE INVENTION

An old-fashioned turning light integrated grip has two modules: the grip and turning signal light modules. The signal light module is mounted on the bar end of the grip. The signal light is so activated that the rider needs to use his little finger to press the switch button on the light because the light is mounted at the bar end of the grip. Due to weak power of little finger's nature, such product is so inconvenient and hard for riders to activate the turning light.

### BRIEF SUMMARY OF THE INVENTION

With references to FIGS. 1, 2, and 3, the invention mainly comprises:

A grip main body that is hollow and has an elongated hole inside its body (for housing signal wire purpose); Alternatively, the said elongated hole can be an elongated recess (please see FIG. 2) instead on the inner wall of the grip main body to reach the same housing purpose;

A turning signal light module that comprises light housings, an electrical system with voltage-raising circuits, LEDs, a power supply, a buzzer, signal wire, and a light-activating switch; The electrical system is equipped with an automatic power-off function that shuts off the signal light when it is being activated over a preset period of time; Due to limited space inside the handle bar and also the preference of lighter weight in bike industry, the power supply is designed to carry only one battery (lower than 2.0V in voltage), making the need of the said voltage-raising circuits; and

A protective outer ring that has a mounting bolt for the purpose of mounting entire product on the handle bar; Another feature of the protective outer ring, moreover, is that the appearance of protective outer ring can be plated with a preferred color, so it also poses well for aesthetic merits. Alternatively, the protective outer ring can be omitted by applying a fixing screw to fix the light housing and the grip together (please see FIG. 3)

When a rider uses his/her thumb to press the switch, the signal is then sent through the signal wire to the said electrical system to activate to flash the turning signal light and the buzzer (the buzzer is used so that rider can tell the activation states of the light without looking at the light). Although the power supply is low, the voltage-raising circuits helps boost up the voltage to a proper level for LED's functioning. When the light is being activated over a preset period of time, the automatic power-off function activates to shut off the light automatically, leaving riders worry-free for forgetting switching off power.

### BRIEF DESCRIPTION OF THE DRAWINGS

FIG. 1: Perspective view of the invention

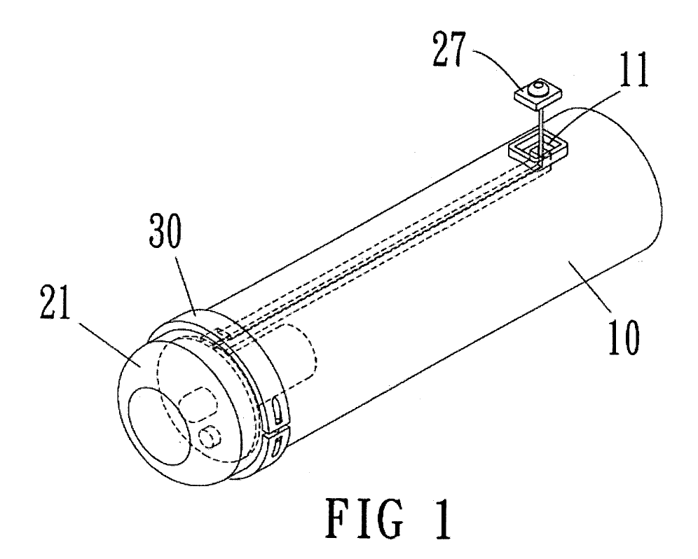

FIG. 2: Sectional view of the invention when adopting an elongated recess as an alternative

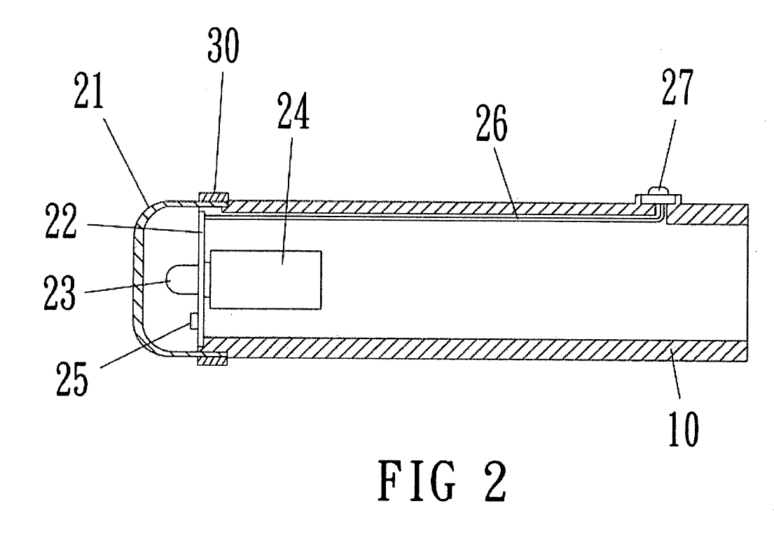

FIG. 3: Alternative design (without protective outer ring) for the invention

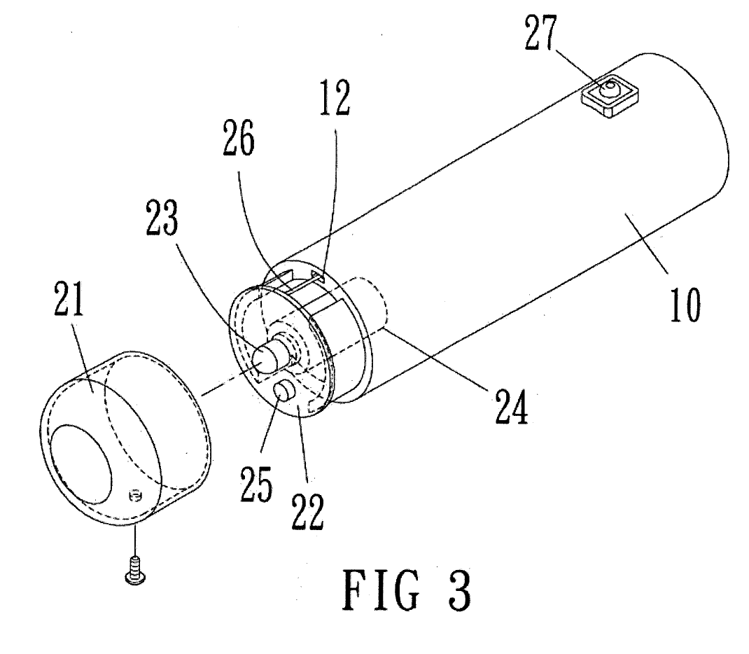

FIG. 4: Perspective view of the preferred embodiment

FIG. 5: The view with the horn-shaped piece

### DETAILED DESCRIPTION OF THE INVENTION

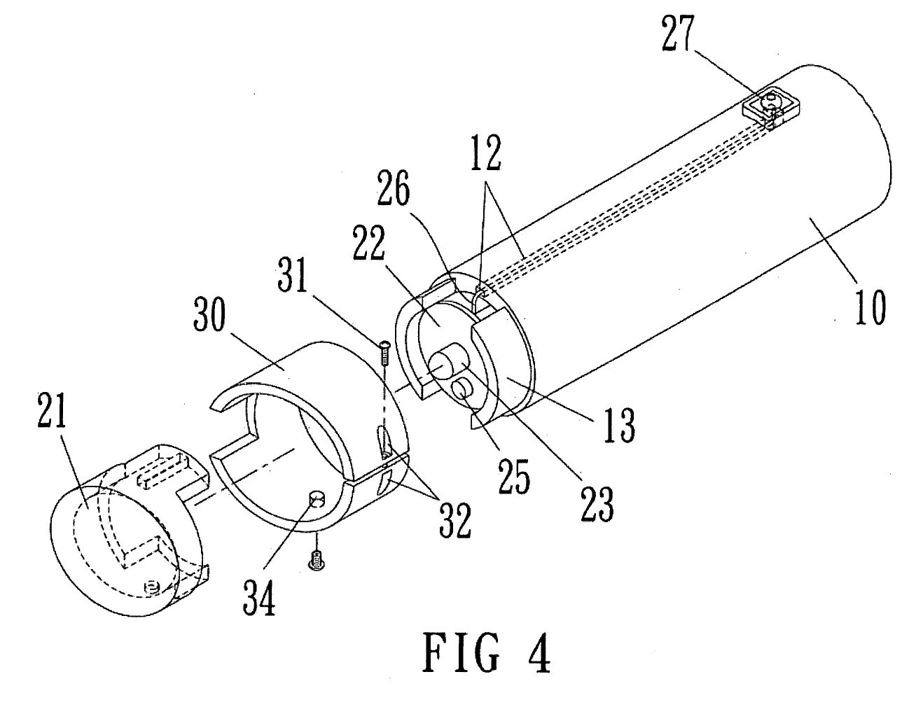

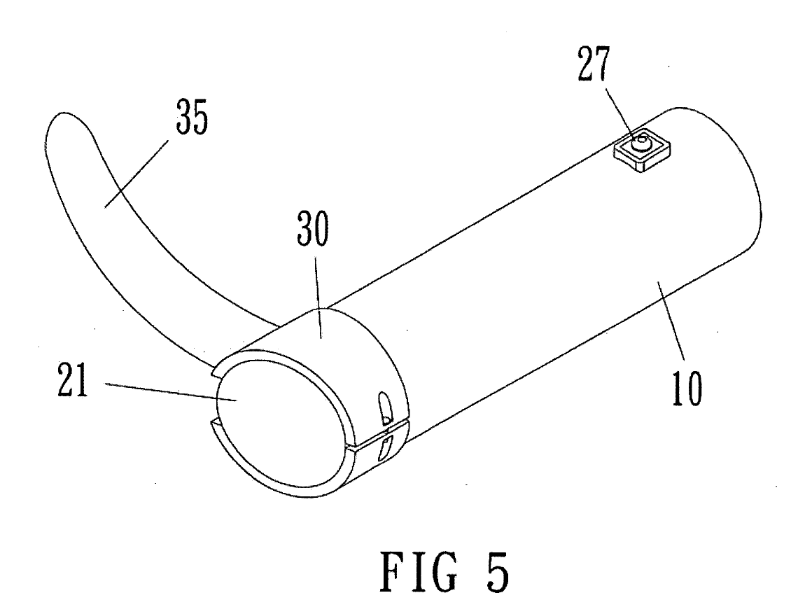

In order to understand better the present invention, please refer to following descriptions and explanations for a preferred embodiment with reference to the attached FIG. 4 and 5. The preferred embodiment of the invention of comprises:

A grip main body 10 that is hollow and has an opening hole 11 near its one end that houses light-activating switch 27, an elongated hole 12 inside its body for housing signal wire 26, and multiple pieces of mounting fins 13 at its end for mounting purpose;

A turning signal light module that comprises light housings 21, an electrical system 22 with voltage-raising circuits, LEDs 23, a power supply 24 that is electrically connected to the said electrical system 22, a buzzer 25, signal wire 26, and a light-activating switch 27; The said electrical system 22 contains of a simple micro controller (not shown in the figures) that carries an automatic power-off function that can shut off the signal light when it is being activated over a preset period of time; The power supply 24 carries a battery.

A protective outer ring 30 that is C-shaped in side view and has a mounting bolt 31, and two mounting holes 32 on its both sides of the C-opening 36 so to cooperate with the mounting bolt 31 for the purpose of mounting entire product onto the handle bar of a bike. Moreover, there is at least one recess window 33 at its front end for the beam to shoot out towards its front direction. Furthermore, there is a fixing hole 34 on the outer ring 30 (at a proper location) for fixing the outer ring 30 with the turning light housing 21 by a screw.

And further for better lighting effects, the protective outer ring 30 and the light housings 21 are slanted designed at the lighting side. When assembly, the outer ring 30 is fitted onto the mounting fins 13 around its outer faces. Then the mounting bolt 31 is tightened against the mounting holes 32 so further to press the mounting fins 13 tightly, thus making entire product mounted firmly on the handle bar. Alternatively, with all features mentioned above, the protective outer ring 30 can further extend out a horn-shaped piece 35 (please see FIG. 5) for adding extra handholding position.

Such an invention provides riders with extra security and conveniences that prior arts do not have. With all aforementioned, the invention deserves grant of a patent based on its capability of industrial application and absolute novelty. The example illustrated above is just an exemplary embodiment for the invention, and shall not be utilized to confine the scope of the patent. Any equivalent modifications within the scope of claims of the patent shall be covered in the protection for this patent.

While certain preferred embodiments have been described and shown in the accompanying drawings, it is to be understood that such embodiments are merely illustrative of, and not restrictive on, the broad invention. Other embodiments that are apparent to those of ordinary skill in the art, including embodiments that do not provide all of the features and advantages set forth herein, are also within the scope of this invention.

Further, it is to be understood that this invention is not limited to the specific construction and arrangements shown and described since various modifications or changes may occur to those of ordinary skill in the art without departing from the spirit and scope of the invention. Accordingly, the scope of the invention is defined by the claims that follow. In the claims, a portion shall include greater than none and up to the whole of a thing.

What is claimed is:

1. A turning signal light integrated grip for bikes comprising:
a grip main body that has an elongated hole inside its body; and
a turning signal light module that comprises light housings, an electrical system, LEDs, a power supply, and a light-activating switch.

2. The turning signal light integrated grip for bikes of claim 1, wherein the said electrical system comprises voltage-raising circuits.

3. The turning signal light integrated grip for bikes of claim 1, wherein the said turning signal light module comprises a buzzer for making sounds.

4. The turning signal light integrated grip for bikes of claim 1, wherein the said electrical system comprises an automatic power-off function that shuts off the signal light when it is being activated over a preset period of time.

5. The turning signal light integrated grip for bikes of claim 1, it further comprises a protective outer ring.

6. A turning signal light integrated grip for bikes comprising:
a grip main body that has an elongated recess on its inner wall; and
a turning signal light module that comprises light housings, an electrical system, LEDs, a power supply, and a light-activating switch.

7. The turning signal light integrated grip for bikes of claim 6, wherein the said electrical system comprises voltage-raising circuits.

8. The turning signal light integrated grip for bikes of claim 6, wherein the said turning signal light module comprises a buzzer for making sounds.

9. The turning signal light integrated grip for bikes of claim 6, it further comprises a protective outer ring.

10. The turning signal light integrated grip for bikes of claim 6, wherein the said electrical system comprises an automatic power-off function that shuts off the signal light when it is being activated over a preset period of time.

11. A turning signal light integrated grip for bikes comprising a protective outer ring that has at least one recess window for the beam to shoot out.

12. The turning signal light integrated grip for bikes of claim 11, wherein the said protective outer ring comprises a horn-shaped piece for extra handholding position.

13. The turning signal light integrated grip for bikes of claim 11, wherein the said protective outer ring is slanted designed.

14. The turning signal light integrated grip for bikes of claim 11, wherein the said protective outer ring that has a mounting bolt, two mounting holes for mounting purpose.

15. The turning signal light integrated grip for bikes of claim 11, wherein the said protective outer ring that has a fixing hole used for fixing with the light housings.

16. The turning signal light integrated grip for bikes of claim 11, wherein the said protective outer ring is slanted designed.
